(19) United States
(12) Patent Application Publication
(10) Pub. No.: US 2016/0040599 A1
(43) Pub. Date: Feb. 11, 2016

(54) COMBUSTION SYSTEM, APPARATUS AND METHOD

(71) Applicant: HAMILTON SUNDSTRAND CORPORATION, Charlotte, NC (US)

(72) Inventor: DAIH-YEOU CHEN, San Diego, CA (US)

(73) Assignee: HAMILTON SUNDSTRAND CORPORATION, Charlotte, NC (US)

(21) Appl. No.: 14/887,363

(22) Filed: Oct. 20, 2015

Related U.S. Application Data
(63) Continuation of application No. PCT/US2014/045793, filed on Jul. 8, 2014.
(60) Provisional application No. 61/846,380, filed on Jul. 15, 2013.

(51) Int. Cl. F02C 7/262; F23R 3/14; F23R 3/00; F02C 7/228

(52) U.S. Cl. CPC F02C 7/262; F02C 7/228; F23R 3/14; F23R 3/002

(57) ABSTRACT

Combustion systems for a gas turbine engines are provided. The combustion system is configured to provide a fuel-air mist to achieve light-off during high altitude start (e.g., at altitudes greater than 45,000 ft.) without flame out. The combustion system may also be configured to provide additional air to the combustion chamber at high altitude to facilitate flame propagation and second stage burn.

### CROSS-REFERENCE TO RELATED APPLICATIONS

This application is a continuation of, claims priority to and the benefit of, PCT/US2014/045793 filed on Jul. 8, 2014 and entitled “COMBUSTION SYSTEM, APPARATUS AND METHOD,” which claims priority from U.S. Provisional Application No. 61/846,380 filed on Jul. 15, 2013 and entitled “COMBUSTION SYSTEM, APPARATUS AND METHOD.” Both of the aforementioned applications are incorporated herein by reference in their entirety.

### FIELD OF INVENTION

The present disclosure relates to the starting and operation of a gas turbine, and more specifically, to high altitude gas turbine starting and operation at or above 45,000 ft (˜13716 m).

### BACKGROUND OF THE INVENTION

Existing high altitude starting technologies typically achieve starting of gas turbines (e.g., auxiliary power units (“APUs”)) at 35,000 ft. (˜10,668 m) to 43,000 ft. (˜13,716 m) of altitude. In order to start gas turbines at higher altitude (e.g., greater than 43,000 ft.), systems may employ oxygen and/or hot main engine air (e.g., bleed air) to initiate an engine start of a gas turbine. These existing methods typically employ complicated structures and plumbing, along with being heavy and very expensive.

### SUMMARY OF THE INVENTION

In various embodiments, a gas turbine combustion system may comprise a combustor, an injector and an igniter. The combustor may comprise a combustion chamber. The combustion chamber may comprise one or more fluid channels to introduce air into at least one of a primary zone and an intermediate zone. The injector may be in fluid communication with the combustion chamber. The injector may also comprise an air handler and an atomizer. The igniter may be coupled to the combustion chamber. The igniter may be configured to ignite a fuel air mixture provided by the injector in the combustion chamber.

In various embodiments, a gas turbine combustor may comprise a combustion chamber, an igniter, and an injector. The combustion chamber may include a primary zone and an intermediate zone. The combustion chamber may further comprise a first hole in fluid communication with the primary zone and a second hole in fluid communication with the intermediate zone. The igniter may be coupled to the combustion chamber and may be configured to generate a spark in the primary zone. The injector may also be coupled to the combustion chamber and may be configured to provide a fuel-air mist in the primary zone.

In various embodiments, a turbine engine may comprise a combustor and a compressor. The combustor may comprise a housing, a combustion chamber and a liner. The combustion chamber may be contained within the housing. The combustion chamber may comprise an injector configured to provide a fuel air mist to the combustion chamber and an igniter configured to ignite the fuel air mist. The combustion chamber may further comprise a first plurality of holes in fluid communication with a primary zone and a second plurality of holes in fluid communication with an intermediate zone. The channel may be defined between the combustion chamber and the housing. The compressor may be in fluid communication with the channel. Fluid from the compressor may be conducted through the channel and to the first plurality of holes and the second plurality of holes of the combustion chamber.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1 is a cross-sectional view of a portion of an auxiliary power unit gas turbine comprising a combustor, in accordance with various embodiments.

FIG. 2 is a perspective view of a combustor chamber, in accordance with various embodiments.

FIG. 3A is a cross-sectional view of a first portion of a combustor showing a fuel injector, in accordance with various embodiments.

FIG. 3B is a perspective view of a piloted-air-blast injector nozzle, in accordance with various embodiments.

FIG. 4A is a cross-sectional view of a duplex injector with a pressure atomization fuel spray in the combustor, in accordance with various embodiments.

FIG. 4B is a cross-sectional view of a piloted-air-blast injector with a swirled atomization fuel spray in the combustor, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the inventions, it should be understood that other embodiments may be realized and that logical, chemical and mechanical changes may be made without departing from the spirit and scope of the inventions. Thus, the detailed description herein is presented for purposes of illustration only and not of limitation. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact.

As used herein, “aft” refers to the direction associated with the tail (e.g., the back end) of an aircraft, or generally, to the direction of exhaust of the gas turbine engine. As used herein, “forward” refers to the direction associated with the nose (e.g., the front end) of an aircraft, or generally, to the direction of flight or motion.

In various embodiments, a gas turbine engine is provided. Gas turbine engine may generally comprise a compressor section, and a combustor. It should be understood that the concepts described herein are not limited to use with gas turbines that are configured as auxiliary power unit.

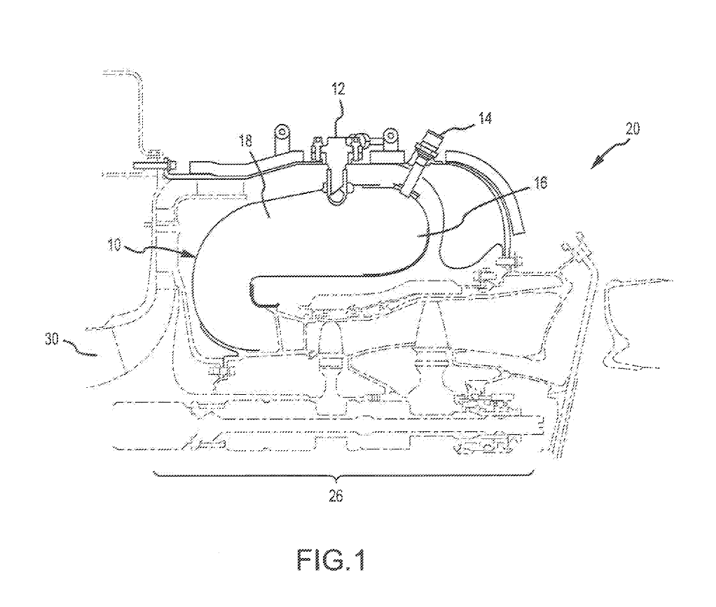

In various embodiments, and with reference to FIG. 1, an APU 20 may comprise a combustor 26 and a compressor 30. Combustor 26 may define a combustion chamber 10. Compressor 30 may be in fluid communication with combustor 26. Combustion chamber 10 may be a volume that is configured to receive fuel and/or air. Combustion chamber 10 may further comprise and/or define a primary zone 16 (also referred to as a primary portion and/or a first portion and an intermediate zone 18 (also referred to as an intermediate portion and/or a second portion). Combustor 26 may further comprise one or more injectors 12 (e.g., a fuel injector, fuel port, nozzle, fuel nozzle, and/or the like) and one or more igniters 14 (e.g., a spark generator).

In various embodiments, injector 12 may be in fluid communication and/or operatively coupled to a fuel supply. Injector 12 may also be in fluid communication, operatively coupled to and/or installed in combustion chamber 10. Further, injector 12 may be configured to supply and/or spray fuel and/or an air-fuel mixture into at least a portion of combustion chamber 10 (e.g., primary zone 16 and/or intermediate zone 18). In this regard, injector 12 may be installed, positioned, angled and/or otherwise configured to spray fuel in a specification region of combustion chamber 10.

For example, injector 12 may be configured to spray fuel into a region associated with and/or proximate to igniter 14. More specifically, the fuel spray (e.g., an air-fuel mixture) may be directed to the region (e.g., primary zone 16) associated with igniter 14. In this regard, igniter 14 may ignite the fuel spray to initiate light off and flame propagation (e.g., start the combustor 26).

In various embodiments, the volume (e.g., primary zone 16 and intermediate zone 18) associated with combustion chamber 10 may comprise atomized fuel. In response to igniter 14 initiating a light off in primary zone 16, the flame associated with the light off may propagate the volume of the combustion chamber 10 from, for example, primary zone 16 to intermediate zone 18. In this regard, the flame propagation generates heat that provides sustained combustion and an appropriate operating range in combustor 26.

In various embodiments, air density is very low at altitudes above 45,000 ft. (˜13,716 m). As such, ignition and/or combustion can be difficult, because oxygen concentration in the air which is needed for ignition and/or combustion is lower relative to the oxygen concentration in air at sea level and/or relative to the oxygen concentrations at altitudes of 43,000 ft. (˜13,106 m) and lower. In order to improve ignition and combustion efficiency, combustor 26 may comprise and/or employ injector 12 that may provide improved fuel atomization, uniform fuel distribution and second stage burning to enhance and prolong flame propagation.

Moreover, the pressure drop across an injector nozzle may not be sufficient to properly atomize fuel at relatively high altitude (e.g., where the air density is relatively low). As such, in order for combustor 26 to start and/or sustain ignition the amount of fuel is may need to be reduced and/or the amount of air in the combustion chamber may need to be increased.

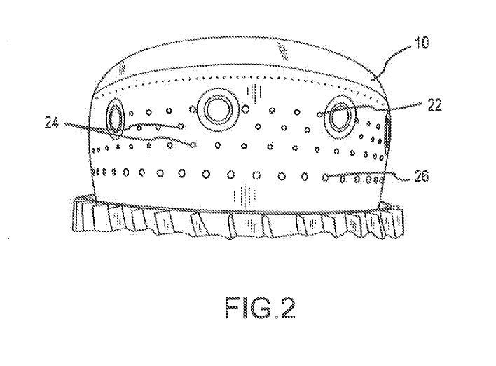

In various embodiments and with reference to FIGS. 1 and 2, combustion chamber 10 may comprise and/or define a number of passages including, for example, one or more primary passages 22 (e.g., primary holes), one or more intermediate passages 24 (e.g., intermediate holes) and one or more dilution passages 26 (e.g., dilution holes). Primary passages 22 may be in fluid communication with primary zone 16. Intermediate passages 24 may be fluid communication with intermediate zone 18. Dilution passages 26 may be in fluid communication with a volume defined by combustion chamber 10 that is adjacent to intermediate zone 18.

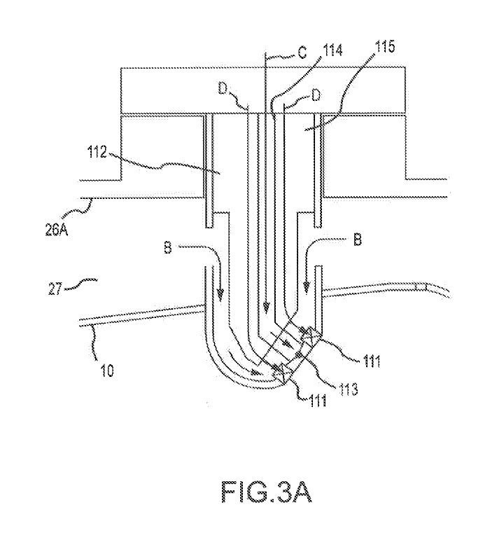

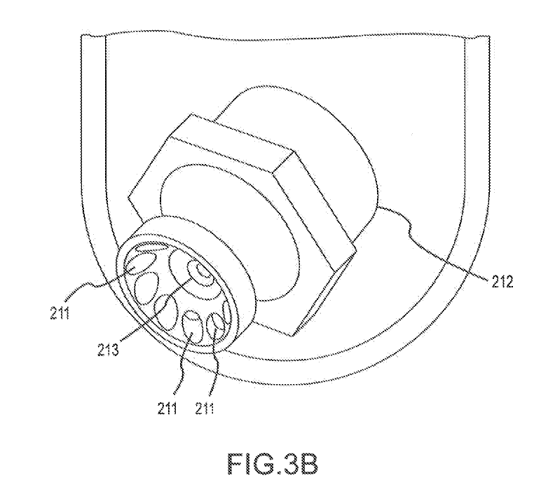

In various embodiments, each of primary passages 22, intermediate passages 24, and dilution passages 26 may also be in fluid communication with the compressor (e.g., through an annulus 27 as shown in FIG. 3A). In this regard, air from the compressor may be conducted to and/or through each of primary passages 22, intermediate passages 24, and dilution passages 26. More specifically, air from the compressor may pass through primary passages 22 which may supply air to primary zone 16 to facilitate starting when fuel from injector 12 is supplied to primary zone 16 and ignited by igniter 14. Air supplied through intermediate holes 24 may increase the amount of air in intermediate zone 18 of combustion chamber 10 to propagate ignition of combustion materials not burned in primary zone 16. Air from dilution passages 26 may be used to cool combustion chamber 10.

In various embodiments and with reference to FIG. 3A, injector 112 may be installed in and/or through a portion of combustor 26 (shown in FIG. 2) such as, for example, combustor case 26A. In this regard, injector 112 is in fluid communication with and/or capable of providing a fluid to combustion chamber 10. A portion of injector 112 may also be in fluid communication with annulus 27. Annulus 27 is the volume and/or fluid channel (e.g., air channel) defined between combustor case 26A and combustion chamber 10. Annulus 27 may be coupled to and/or in communication with the compressor. In this regard, a fluid flow B (e.g., air) from the compressor may be conducted through annulus 27 and into one or more portions and/or flow channels of injector 112, as shown in FIG. 3.

In various embodiments (and as discussed herein), injector 112 may comprise a first fuel channel 114 and a second fuel channel 115. Injector 112 may be coupled to and/or configured to receive a fuel fluid flow C through first fuel channel 114. Fuel fluid flow C may be delivered during start (e.g., initial ignition) and during combustor operation. Injector 112 may be coupled to and/or configured to receive a fuel fluid flow D through the second fuel channel 115. Fuel fluid flow D may be delivered during combustor operation to provide sufficient fuel for sustained combustor operation.

In various embodiments and in operation, injector 112 may further comprise one or more air handler 111 and one or more pressure atomizer 113. Fluid flow B may be conducted through annulus 27 and may interact with one or more air handler 111. In this regard, air handler 111 may introduce turbulence in fluid flow B. Air handler 111 may also bias or otherwise direct fluid flow B in any suitable direction. Fluid flow C may be conducted through injector 112 to pressure atomizer 113. In this regard, fluid flow C (e.g., fuel), may be discharged from injector 112 through pressure atomizer 113 as a mist. The mist may interact with the biased and/or turbulent fluid flow B (e.g., air), to create an atomized air-fuel discharge into combustion chamber 10. This atomized air-fuel mixture may provide lower ignition and/or combustion ranges and may promote flame propagation and combustor 26 operation.

In various embodiments, and with reference to FIG. 3B, injector 212 may comprise a fuel diffuser 213 and one or more air swirlers 211. Fuel diffuser 213 may be configured to diffuse and/or atomize fuel from injector 212. The atomized fuel may also be mixed with air exhausted from one or more air swirler 211. In this regard, the resulting atomized fuel-air mixture is suitable for light off and/or ignition at relatively high altitudes (e.g., altitudes above approximately 45,000 ft.).

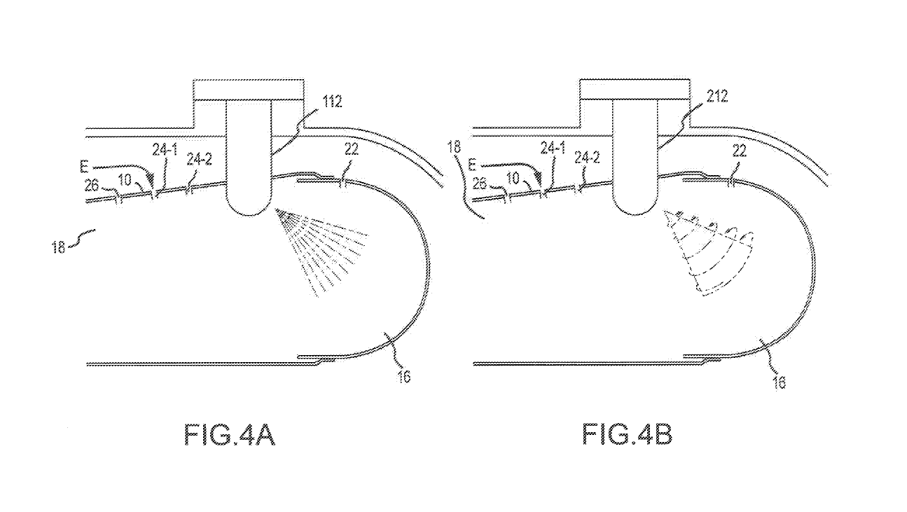

In various embodiments, and with reference to FIGS. 4A-4B, injector 12 may be at least one of a duplex injector 112 (as shown in FIG. 4A) or a piloted-air-blast injector 212 (as shown in FIG. 4B). In various embodiments, duplex injector 112 may be configured to propagate a fuel-air mixture that initially conducts fuel-air particles in primary zone 16. In various embodiments, piloted-air-blast injector 212 may be configured to create a swirling fuel-air mixture that initially conducts fuel-air particles in primary zone 16. In this regard, duplex injector 112 and/or piloted-air-blast injector 212 may produce a fuel-air spray that uniformly distributes fine fuel-air particles in primary zone 16 for light-off and flame propagation. Duplex injector 112 and/or piloted-air-blast injector 212 may also propagate and/or conduct the fine fuel-air particles through primary zone 16 into the intermediate zone 18 to prolong flame propagation and/or operation of combustor 26.

In various embodiments, during high altitude light-off, the primary fuel system coupled to injector 12 (e.g., duplex injector 112 and/or piloted-air-blast injector 212) uses the pressure atomization or air-blast atomization to provide a fuel spray for reliable engine light-off. After light-off, the fuel/air ratio of primary zone 16 may be reduced for easy flame propagation and/or rapid temperature rise. Because the air density is relatively low at altitudes above 45,000 ft. and the fuel/air ratio of the incomplete combustion products is relatively fuel rich in primary zone 16 after light off and/or ignition, additional air may be needed to continue operation of combustor 26. The additional air may be provided through primary passages 22 and intermediate passages 24-1 and 24-2. As noted herein air may also be supplied through dilution passages 26 to regulate the temperature in combustion chamber 26. In various embodiments, the primary passages 22 and intermediate passages 24 may be configured to conduct air from annulus 27 (as shown in FIGS. 4A and 4B) into the interior volume defined by combustion chamber 10. In this regard, the fluid (e.g., air) introduced in combustion chamber 10 decreases the fuel-air ratio to promote second stage burning (e.g., by increasing the oxygen level in the volume defined by combustion chamber 10).

In various embodiments, APU 20 may be configured to provide power to aircraft systems such as, for example, environmental control system, navigation systems, entertainment systems, and/or any other suitable systems. During aircraft operation, the main engine may be capable of providing this power. However, to improve operating efficiency, APU 20 may be employed to reduce the load on one or more of the main engines and/or to provide power to various aircraft systems.

In various embodiments, APU 20 may be provided as a portion of an extended range two engine aircraft population system (e.g., an ETOPS system). APU 20 may be capable of operating above approximately 45,000 ft., providing a greater operating range (e.g., operating altitude) than existing extended range propulsion systems.

Thus, in various embodiments, the combustion systems, apparatuses, and methods described herein may provide, for example, improved combustion ignition and flame propagation, reduced combustor weight, and lower overall combustor cost.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A gas turbine combustion system, comprising:
a combustor comprising a combustion chamber, the combustion chamber comprising one or more fluid channels to introduce air into at least one of a primary zone and an intermediate zone, the primary zone being enclosed by and defined by a domed portion of the combustor;
an a dual channel injector in fluid communication with the combustion chamber and configured to discharge fuel into the primary zone, the injector comprising an a first fuel channel, a second fuel channel, a plurality of air swirler ports, and an atomizer,
wherein the plurality of swilrer ports are configured to receive compressor airflow,
wherein the plurality of swirler ports are disposed circumferentially about the second fuel channel, and
wherein the swirler ports are configured to discharge to turbulent air flow in response to fuel being supplied through the first fuel channel and the second fuel channel to the atomizer; and
an igniter coupled to the combustion chamber, wherein the igniter is configured to ignite a fuel air mixture provided by the injector in the combustion chamber.

2. The gas turbine combustion system of claim 1, wherein the injector is configured to provide the fuel air mixture in the primary zone.

3. The gas turbine combustion system of claim 1, wherein the igniter is located adjacent to the primary zone.

4. The gas turbine combustion system of claim 1, wherein the injector comprises a first fuel channel and a second fuel channel.

5. The gas turbine combustion system of claim 1, wherein fuel is delivered to the combustion chamber through the first fuel channel in response to a starting operation.

6. The gas turbine combustion system of claim 1, wherein the atomizer is a diffuser.

7. The gas turbine combustion system of claim 6, wherein the diffuser is configured to discharge a mist of fuel.

8. The gas turbine combustion system of claim 7, wherein the air handler is an air swirler.

9. The gas turbine combustion system of claim 8, wherein the air swirler is configured to discharged a biased air flow that mixes with the mist of fuel.

10. A gas turbine combustor, comprising:
a combustion chamber including a primary zone and an intermediate zone, the primary zone being enclosed by and defined by a domed portion of the combustion chamber, the combustion chamber further comprising a first hole in fluid communication with the primary zone and a second hole in fluid communication with the intermediate zone;
an igniter coupled to the combustion chamber, the igniter configured to generate a spark in the primary zone; and
an injector coupled to the combustion chamber, and the injector configured to provide a fuel-air mist in the primary zone,
the injector comprising,
a first fuel channel, a second fuel channel, a plurality of air swirler ports, and an atomizer,
the air handler is in fluid communication with the swilrer ports,
the plurality of swirler ports are disposed circumferentially about the second fuel channel, and
the swirler ports are configured to discharge to turbulent air flow in response to fuel being supplied through the first fuel channel and the second fuel channel to the atomizer.

11. The gas turbine combustor of claim 10, further comprising an annulus defined between the gas turbine combustor housing and the combustion chamber.

12. The gas turbine combustor of claim 11, wherein the annulus is configured to receive a fluid flow from a compressor.

13. The gas turbine combustor of claim 11, wherein the first hole and the second hole are in are in fluid communication with the annulus.

14. The gas turbine combustor of claim 10, wherein the injector comprises an air handler.

15. The gas turbine combustor of claim 14, wherein the injector comprises a fuel atomizer.

16. The gas turbine combustor of claim 15, wherein the air handler is configured to create at least one of a turbulent air flow and a rotating airflow.

17. The gas turbine combustor of claim 15, wherein fuel is exhausted as a mist from the fuel atomizer and mixed with air exhausted from the air handler to create the fuel-air mist.

18. An APU, comprising:
a combustor comprising,
a housing,
a combustion chamber contained within the housing, combustion chamber having a domed portion defining a primary zone, the combustion chamber comprising an injector comprising;
an injector body,
a first fuel channel disposed within the injector body,
a second fuel channel disposed within the injector body and about the first fuel channel,
an atomizer in fluid communication with and configured to exhaust fuel from the first fuel channel and the second fuel channel, and
a plurality of air swirler ports disposed circumferentially about the second fuel channel, the plurality of the air swirler ports are configured to discharge to turbulent air flow in response to fuel,
the injector configured to provide a fuel air mist to the combustion chamber and an igniter configured to ignite the fuel air mist, the combustion chamber comprising a first plurality of holes in fluid communication with a primary zone and a second plurality of holes in fluid communication with an intermediate zone,
a channel defined between the combustion chamber and the housing;
a compressor in fluid communication with the channel, wherein fluid from the compressor is conducted through the channel and to the first plurality of holes and the second plurality of holes of the combustion chamber.

19. The APU of claim 18, wherein the injector comprises an air handler and a fuel atomizer.

20. The APU of claim 18, wherein the injector is configured to provide the fuel air mist in a volume adjacent to the igniter to achieve light off.
